(19) United States
(12) Patent Application Publication
(10) Pub. No.: US 2005/0222712 A1
(43) Pub. Date: Oct. 6, 2005

(54) Salesperson robot system

(75) Inventor: Atsuo Orita, Wako-shi (JP)

Correspondence Address: RANKIN, HILL, PORTER & CLARK LLP, 4080 ERIE STREET, WILLOUGHBY, OH, 44094-7836, US

(73) Assignee: Honda Motor Co., Ltd., Tokyo (JP)

(21) Appl. No.: 11/006,033

(22) Filed: Dec. 7, 2004

(30) Foreign Application Priority Data
Mar. 31, 2004 (JP) 2004-105116

(51) Int. Cl. G06F 19/00

(52) U.S. Cl. 700/246; 700/245

(57) ABSTRACT

The salesperson robot is provided with a customer information database (5) including face information, a merchandise information database (4) and a speech processing unit (15) for speaking to a customer and listening to what a customer has to say. The robot is thereby enabled to provide relevant merchandise information to the customer both accurately and promptly. In particular, if the customer is already registered in the customer information database, the system may be able to identify the customer from the face information and promptly provide the customer with the information that suits the particular customer even without asking the customer. If the customer is not registered in the customer information database, the robot may receive the customer in such a manner as would suit a customer visiting the shop for the first time. In either case, the customer is able to obtain necessary information from the customer, and give information to the customer in a pleasant and efficient manner in each case.

### TECHNICAL FIELD

The present invention relates to a salesperson robot system that includes a salesperson robot that can explain the features of various items of merchandise to potential buyers in shops or the likes.

### BACKGROUND OF THE INVENTION

In places such as automobile dealers and home appliance shops, potential buyers or customers may require an extremely large amount of information for them to make appropriate choices because of a wide variety of items of merchandise that need to be considered and the complexity of the various features of each item of merchandise. Although it is essential for the salesperson to be able to furnish such information to each customer to allow the customer to make well-informed choices, this task may require too much effort for the salesperson to be able to successfully manage depending on the circumstance.

Oftentimes, information on the merchandise and/or the customers is kept in a computer so as to be available for each salesperson to utilize. However, such information can be retrieved only by a salesperson operating a computer or a terminal connected to a central computer, and this cannot be executed as efficiently as desired. It is therefore desirable if the computer were able to communicate directly with the customer and furnish him/her with appropriate information from its information storage, instead of a human salesperson.

A number of proposals have been made by the assignee of this application to have a robot interface with humans. Reference should be made to Japanese patent laid open publications No. 11-31184 and No. 2002-216129. By making use of such available technology, it would be possible to have a robot receive a customer and identify the customer even before speaking with the customer. Once having identified the customer, the robot would be able to furnish the customer with suitable information, and maximize the satisfaction of the customer. If the customer is a new customer on whom the robot has no data, the robot may inquire the customer so as to collect information that is required for the robot to retrieve information which the customer is likely to be interested in.

### BRIEF SUMMARY OF THE INVENTION

In view of such problems of the prior art and the recognition of the inventors, a primary object of the present invention is to provide a robot system that can present information on various goods to a customer both accurately and promptly.

A second object of the present invention is to provide a robot system that can favorably serve a customer by providing information which the customer needs.

According to the present invention, these and other objects can be accomplished by providing a salesperson robot system including a robot placed in certain premises for giving information to a customer who is in the premises, the robot comprising: a customer information database storing information on a plurality of customers including face image information of each customer; a merchandise information database storing information on merchandise; a camera for capturing an image of a customer; a customer identifying means for identifying the customer by comparing face image information acquired by the camera with the face image information stored in the customer information database; information retrieving means for retrieving information from the merchandise information database that suits the customer if the customer is identified as one stored in the customer information database; and information providing means for providing the retrieved information to the customer.

Thereby, the robot is enabled to determine if the customer who has just walked into a shop such as an automobile dealer is registered in the customer information database. If the customer is a registered customer, the robot is able to promptly provide the customer with the information which the customer is most likely to be interested in. If the customer cannot be found in the customer information database, the robot is able to speak with the customer in a manner appropriate to the customer who has visited the shop for the first time. The robot preferably comprises traveling means such as legs, wheels and crawlers at least for moving toward the customer to make a favorable impression on the customer.

The information providing means may comprise a speech generating unit including an ECU and a speaker connected to the speech generating unit so that the information may be conveyed to the customer in a clear and familiar manner. In this case, the speech generating unit may function as a speech synthesis unit.

The information providing means may comprise a display unit for presenting information in the form of graphic and/or text information. This facilitates the presentation of information to the customer. The display unit may be installed in a part of the robot such as the chest of the robot, or may be adapted to be held by the arms of the robot.

The robot may further comprise a speech recognition unit for listening to what the customer says, the speech recognition unit being functionally connected to the information retrieving means so that appropriate information may be retrieved from the merchandise information database according to information acquired by the speech recognition unit. Thereby, the system is able to receive specific requests for information, and is therefore able to provide information most appropriate for the customer. Alternatively or additionally, the robot may be provided with a touch panel display or input keys so the customer may be able to enter requests for specific information by operating the touch panel display or input keys.

The system may further comprise customer information database updating means for updating the customer information database according to the information acquired by the speech recognition unit so that the customer information is constantly updated, and the system is able to provide information that always suits the customer.

The robot may further comprise a behavior generating unit and a body movement actuator functionally connected to the behavior generating unit for moving a part of the robot, typically, to direct the customer's attention to a particular point of interest so that the information can be provided to the customer in a clear and attractive manner.

The system may further comprise an information database which is provided separately from the robot to store a master database, including the customer information database and merchandise information database or replicas thereof, which is adapted to be downloaded and updated by the robot. Thereby, the merchandise information can be constantly updated, and the customer may be given with the most up-to-date information at all times.

If the system is equipped with a communication unit for transmitting information obtained from the merchandise information database to an information terminal carried by the customer, the customer is allowed to study the contents of the available information at his/her leisure. The information terminal may consist of a mobile phone or a personal computer. The data transmitted to the information terminal may be in the form of Email which is attached with a file containing merchandise information or which indicates the address of the web site describing the merchandise of interest.

Thus, according to the present invention, the system is able to identify the customer if the customer is already registered in the customer information database and promptly provide the information that suits the particular customer even without asking customer. If the customer is not registered in the customer information database, the robot may receive the customer in such a manner as would suit a customer visiting the shop for the first time. In either case, the customer is able to obtain necessary information in a pleasant and efficient manner.

### BRIEF DESCRIPTION OF THE DRAWINGS

Now the present invention is described in the following with reference to the appended drawings, in which:

FIG. 1 is a block diagram of the robot system including a salesperson robot and an information managing server embodying the present invention;

FIG. 2 is a side view showing the salesperson robot of FIG. 1 explaining an automobile to a customer; and

FIG. 3 is a flowchart showing the process executed by the salesperson robot of FIG. 1.

### DETAILED DESCRIPTION OF THE PREFERRED EMBODIMENTS

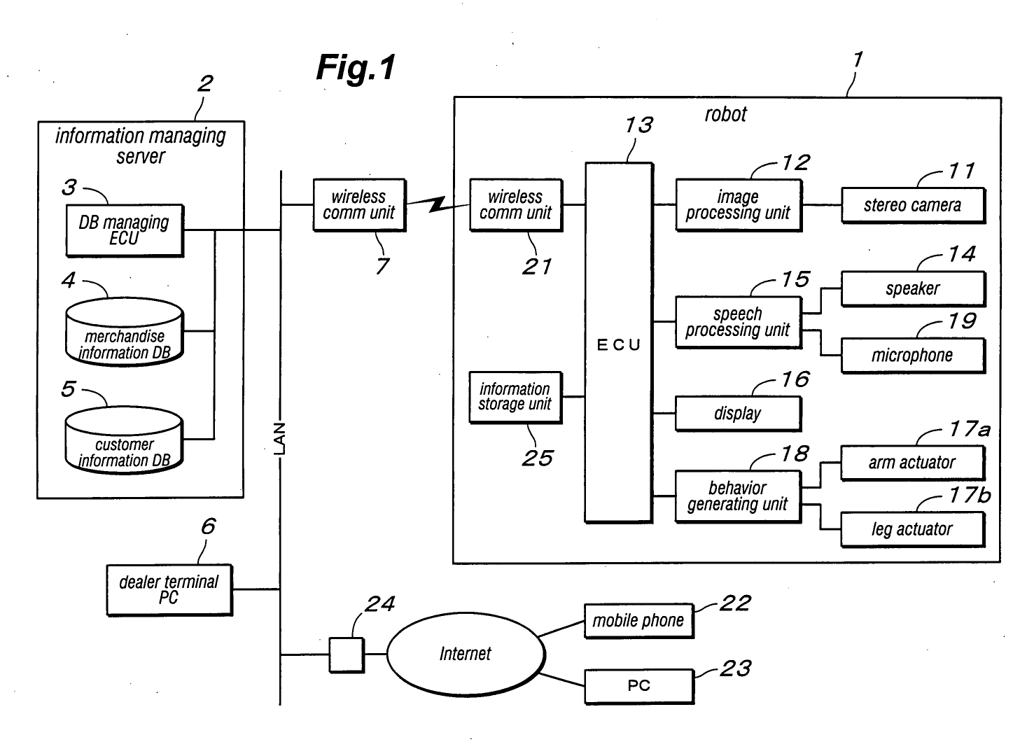

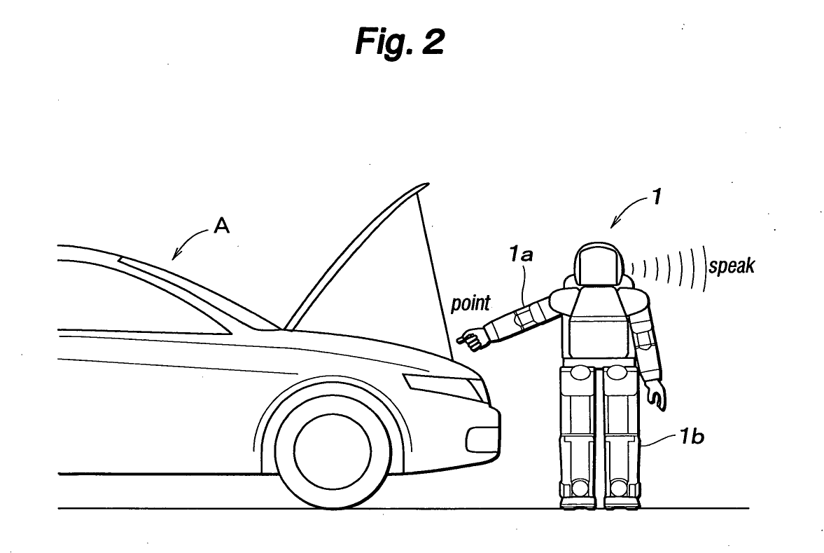

FIG. 1 is a block diagram of a system including a salesperson robot and an information managing server 2 according to the present invention, and FIG. 2 is a side view of the robot 1 as it explains the features of an item of merchandise such as an automobile to a customer. The robot 1 is stationed at a dealer or shop to explain about automobiles to customers who visit the dealer. An information managing server 2 is normally used by the managing department of the dealer, and stores various pieces of information including the various features of the automobile models which the dealer carries. The information managing server 2 may provide such information also to the robot 1 as described hereinafter.

The information managing server 2 includes a database managing ECU 3, a merchandise information database 4 and a customer information database 5. A plurality of PCs 6 are connected to the server 2 via a network to serve as dealer terminals. The server 2 is also connected to a wireless communication unit 7 for communicating with the robot 1 as described hereinafter. The merchandise information database 4 contains information on each of a number of automobile models, and the customer information database 5 contains information on each of a number of registered customers which is collected from the past transactions and/or interviews with the customers.

The robot 1 is provided with a wireless communication unit 21 by which the robot 1 is able to download information on automobile models and customers stored in the merchandise information database 4 and customer information database 5, respectively, via the wireless communication unit 7. The information downloaded from the server 2 is stored in an information storage unit 25 of the robot 1. To speed up the processing of information by the robot 1, the robot 1 may acquire only the information related to the particular customer it is about to serve and the merchandise information which the customer is likely to be interested in. If desired, it is possible to store all the information that is needed in the information storage unit 25 by providing it with an adequate capacity, and update the information by accessing the server 2 from time to time.

The robot 1 is provided with a stereoscopic camera 11 for capturing the image of the customer and an image processing unit 12 for extracting data that is required to identify the customer from the captured image. An ECU 13 compares the data extracted by the image processing unit 12 with the face data stored in the customer information database 5 to identify the customer.

The stereoscopic camera 11 includes a pair of color CCDs arranged laterally one next to the other like human eyes, and the image processing unit 12 extracts a face image that represents the key features of each customer from the image captured by the camera 11. The customer information of each customer who has visited the dealer in the past including the face data is stored in the customer information database 5, and a customer ID can be obtained by comparing the face data obtained from the customer who has just walked into the dealer with the face data in the customer information database 5.

The face data is created in the image processing unit 12 as described in the following. A distance image embedded with the distance information based on the difference between the images obtained by the right and left CCDs of the camera 11 is created. A time difference image is obtained by extracting regions from the distance image that represent movement from the difference in the image in time. A human is identified as a region where movement is most prominent. Using a dynamic outline model, the outline of the human is extracted. The face region is then identified according to the skin color, and the characteristic points of the face are matched for normalization before the face data based on vector representation is created.

The ECU 13 of the robot 1 retrieves the customer information corresponding to the customer identified by the customer ID, and selects an automobile model that is considered to be most appropriate for the customer. The customer information includes the customer ID for identifying the customer, personal information such as the name, gender and address, and the kinds of automobile models the customer is interested in. Typically, an automobile model is selected according to the contents of the personal information. If the customer has visited the dealer in the past, the selection may be modified according to the current interview with the customer. If there is any new relevant information or the previously provided information is updated, such updated information may be conveyed to the customer. At any event, the robot interviews the customer to hear what the customer wants, and provides corresponding information to the customer.

For the purpose of presenting the information on the automobile models selected by the information selection process, the robot 1 is provided with a speaker 14 and a speech processing unit 15 for generating a speech output for driving the speaker 14. The speech processing unit 15 is provided with the functions of a speech recognition unit as well as a speech generating unit as described hereinafter.

Once the information to be presented is selected by the ECU 13, the corresponding text and/or graphic information is forwarded to a display unit 16 to show it on the screen thereof. The display unit 16 may be installed on the chest of the robot 1, for instance, or may also be provided separately from the robot 1. In the latter case, the robot 1 may be adapted to hold the display unit 16 with its arms 1a to show the screen to the customer.

The robot 1 is additionally provided with arm actuators 17a, leg actuators 17b and a behavior generating unit 18 for generating appropriate behavior information and driving the actuators 17a and 17b accordingly. For instance, when the robot 1 has spotted a customer, the behavior generating unit 18 causes the robot 1 to approach the customer by using the leg actuators 17b to actuate the legs 1b. Also, at the same time as presenting information to the customer, the arm actuators 17a may actuate the arms 1a so as to make the robot 1 look more attractive to the customer and/or to draw the attention of the customer to a particular point.

In particular, to complement the oral and visual presentation of the information through the speaker 14 and display unit 16, the robot 1 may point any particular item of merchandise or a particular part of the merchandise by using the arms 1a as shown in FIG. 2. For this purpose, the ECU 13 forwards pointing information to the behavior generating unit 18 so that the robot 1 may point the actual automobile A that is the current topic and/or point a particular part of the automobile A such as the engine so as to correspond to the ongoing oral or graphic presentation of the information on the automobile.

The robot 1 is required to have at least arms 1a to be able to point any particular point, and is preferably formed so as to simulate an upper half part of a human body. For the robot 1 to be able to move about within the premises of the dealer, it is preferably provided with legs 1b or other traveling means such as wheels and crawlers.

The robot 1 is additionally provided with a microphone 19 to listen to what the customer has to say. The speech processing unit 15 analyzes the output signal from the microphone 19, and converts it to text information. Based on the knowledge gained from the text information, the ECU 13 selects appropriate information from the merchandise information database 4, and executes the corresponding presentation of the information via the speech generated by the speaker 14 and speech processing unit 15 and the graphic/text presentation shown on the display unit 16.

Thus, by means of this dialog with the customer, the robot 1 is able to collect new information on what the customer prefers and interested in. Once the interview with the customer has been concluded, the ECU 13 generates update information according to the contents of the preceding dialog with the customer, and updates the customer information in the information storage unit 25 accordingly. The update information is also transmitted to the database managing ECU 3 to update the customer information in the customer information database 5.

To enable the robot 1 to provide as full an information as possible to the customer, the robot 1 may be adapted to transmit the relevant information to an information terminal carried by the customer. In the illustrated embodiment, supplemental information on the particular model is transmitted to the information terminal of the customer which may consist of a mobile phone 22 or a PC 23 via LAN or the Internet via a modem 24 that is connected to the LAN. The information may be contained in a file, for instance in the PDF format, attached to an Email or the Email may include a URL of a web page containing the information on the model.

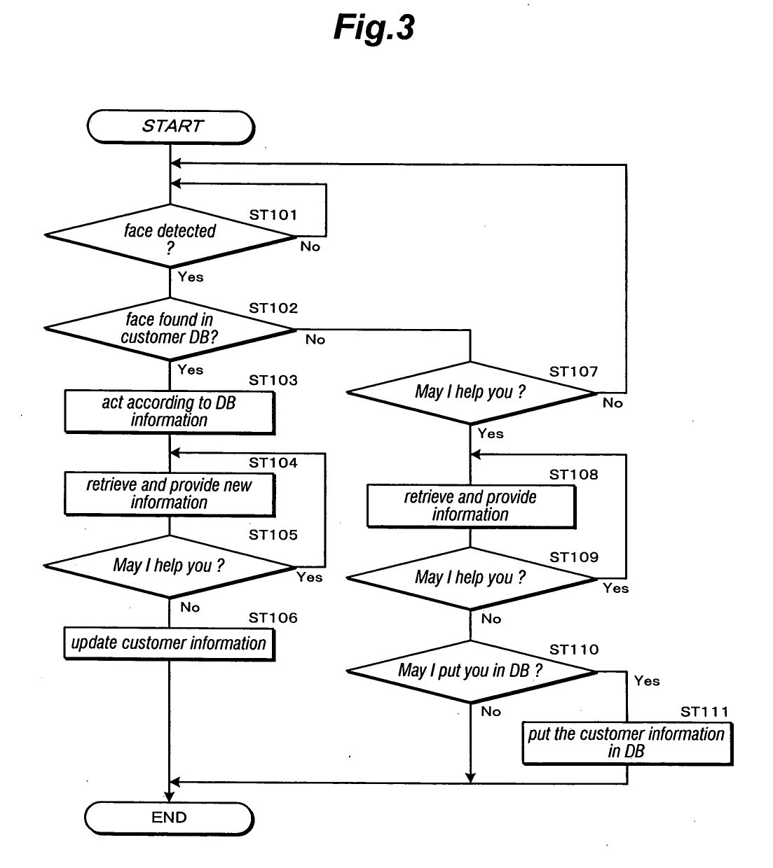

FIG. 3 is a flowchart showing the control process that is executed in connection with the robot 1 illustrated in FIG. 1. The face data of the customer who has just walked into the dealer is acquired by the stereo camera 11 and image processing unit 12 in step 101. The ECU 13 determines if the customer detected in step 101 can be found in the customer information database 5 in step 102. If the customer is found among the registered customers in the customer information database 5 or has visited the dealer before, the program flow advances to step 103.

In step 103, the ECU 13 retrieves information on the customer, and speaks with the customer according to this information, for instance by calling the customer by his/her name. The ECU 13 then looks for information that is known to interest the customer, and has been updated or renewed since the last time the customer visited the dealer. The robot 1 then starts giving the explanation on the model by means of the speech generated by the speech processing unit 15 and speaker 14, the graphical/text presentation on the display unit 16 and the gesture using the behavior generating unit 18 and arm actuators 17a.

In step 105, the robot speaks to the customer by saying, for instance, “May I help you ?”, and listens to what the customer says in response. The robot 1 then tries to understand if the customer needs a help or not, and if the customer needs a help, determines what the customer wants from the information gathered by the microphone 19 and speech processing unit 15. If the customer desires to have any particular information, the robot 1 analyzes the customer's desire, and retrieves the relevant information to convey it to the customer by speech. This is repeated in the manner of a dialog until the customer has received all of the information he/she desires to have. Once the customer has no more request for any information, the program flow advances to step 106, and creates update information according to the information given to the customer and information gathered during the preceding interview with the customer. The update information is thereafter forwarded to the information managing server 2 to update the customer information database 5.

If no matching customer is found among those registered in the customer information database 5 in step 102 or the customer has walked into the dealer for the first time, the program flow advances to step 107 where the robot 1 speaks to the new customer to inquire what the customer wants. If the robot 1 has succeeded in determining what the customer wants, the robot 1 retrieves the corresponding information from the merchandise information database 4 to provide the customer with relevant merchandise information in step 108. When the customer's request for information has been exhausted in step 109, the program flow advances to step 110 to inquire the customer if his/her personal information such as the name and address may be recorded in the customer information database 5. If the customer agrees to it, the program flow advances to step 111 to inquire the personal information, and forwards the personal information along with the information that was gathered during the interview with the customer to the information managing server 2 to register the information in the customer information database 5.

The robot 1 according to the present invention is thus able to provide relevant merchandise information to the customer both accurately and promptly. Therefore, when such a robot is placed in a dealer or other shop, the customer can readily receive exactly the kind of information which he/she needs, and the human resources can be directed to other useful purposes that a robot 1 is unable to accomplish. Although the robot was stationed in an automobile dealer in the illustrated embodiment, the robot system of the present invention is useful in other places such as expositions, sales promotion activities, fairs, and retail and wholesales shops and stores for other lines of merchandise, among other possibilities.

Although the present invention has been described in terms of a preferred embodiment thereof, it is obvious to a person skilled in the art that various alterations and modifications are possible without departing from the scope of the present invention which is set forth in the appended claims.

1. A salesperson robot system including a robot placed in certain premises for giving information to a customer who is in the premises, the robot comprising:
a customer information database (5) storing information on a plurality of customers including face image information of each customer;
a merchandise information database (4) storing information on merchandise;
a camera (11) for capturing an image of a customer;
a customer identifying means (13) for identifying the customer by comparing face image information acquired by the camera with the face image information stored in the customer information database;
information retrieving means (13) for retrieving information from the merchandise information database that suits the customer if the customer is identified as one stored in the customer information database; and
information providing means (14, 16) for providing the retrieved information to the customer.

2. A salesperson robot system according to claim 1, wherein the information providing means comprises a speech generating unit (15) including an ECU and a speaker (14) connected to the speech generating unit.

3. A salesperson robot system according to claim 1, wherein the information providing means comprises a display unit (16) for presenting information in the form of graphic and/or text information.

4. A salesperson robot system according to claim 1, further comprising a speech recognition unit (15) for listening to what the customer says, the speech recognition unit being functionally connected to the information retrieving means so that appropriate information may be retrieved from the merchandise information database according to information acquired by the speech recognition unit.

5. A salesperson robot system according to claim 4, further comprising customer information database updating means (7, 21, 13) for updating the customer information database according to the information acquired by the speech recognition unit.

6. A salesperson robot system according to claim 1, further comprising a behavior generating unit (18) and a body movement actuator (17a) functionally connected to the behavior generating unit for moving a part of the robot.

7. A salesperson robot system according to claim 1, further comprising an information database which is provided separately from the robot to store a master database, including the customer information database (5) and merchandise information database (4) or replicas thereof, which is adapted to be downloaded and updated by the robot.

8. A salesperson robot system according to claim 1, further comprising a communication unit (24) for transmitting information obtained from the merchandise information database to an information terminal (22, 23) carried by the customer.

9. A salesperson robot system according to claim 1, wherein the robot further comprises traveling means (1b, 17b) at least for moving toward the customer.
